(19) United States
(12) Patent Application Publication
(10) Pub. No.: US 2012/0184404 A1
(43) Pub. Date: Jul. 19, 2012

(54) Damping of Plantary Gears with Flex-Pins for Wind Turbines

(75) Inventors: Anthony Chobot, Goleta, CA (US); Tyler Mayer, Carpinteria, CA (US); Edwin C. Hahlbeck, Pewaukee, WI (US); Amir S. Mikhail, Santa Barbara, CA (US)

(73) Assignee: Clipper Windpower, LLC, Carpinteria, CA (US)

(21) Appl. No.: 13/375,717

(22) PCT Filed: Oct. 29, 2009
(86) PCT No.: PCT/IB09/07265

§ 371 Date: Apr. 3, 2012

Related U.S. Application Data
(60) Provisional application No. 61/269,682, filed on Jun. 25, 2009.

(51) Int. Cl. F16H 57/08

(52) U.S. Cl. 475/347

(57) ABSTRACT

A gear assembly includes a flexible pin mounted to and supported by a planet carrier at one end. A tubular sleeve extends coaxially about the flexible pin and provides a deflection space between said tubular sleeve and said flexible pin. Said flexible pin moves, flexes or deflects under operational loads. A damping element is contained at least partially within the deflection space and surrounds at least partially said flexible pin.

### BACKGROUND OF THE INVENTION

1. Field of the Invention

This invention relates in general to gear systems and, more particularly, to damping of a flex-pin in a planetary gear system.

2. Description of the Prior Art

A special form of cantilevered support for gear elements contains a sleeve element concentric to the mounting pin that deflects in a manner that the outside of the sleeve remains parallel to the system axis. This is commonly referred to as a “flex-pin”. In addition to parallel deflection, these devices have an engineered spring rate to assist in equalizing loads in multi-gear, split-power systems, including planetary systems. The invention disclosed in U.S. Pat. No. 3,303,713, to R. J. Hicks has significant application in heavy-duty transmissions, especially when increasing power density by using planet gears in an epicyclical configuration.

A planetary gear has a pin, which is pressed into only one wall of a planetary gear set carrier. At the free end of the pin, an annular sleeve and bearing assembly support a gear, which rotates on the free end of the pin. Under load, opposing bending forces in the sleeve and pin offset one another, resulting in zero misalignment across a broad range of torque. This enables much simpler gear design, which has a higher torque capacity.

In addition to parallel deflection, these devices have an engineered spring rate to assist in equalizing load in multi-gear, split-power systems, including planetary systems. Increased power density is accomplished by using three or more planet gears in an epicyclical configuration. These systems normally use spur gears. Spur gears are shaped as a cylinder with teeth that project radially, and the leading edges of the teeth are aligned parallel to the axis of rotation. These gears are fitted to parallel axles so they can mesh correctly. In helical gears the leading edges of the teeth are not parallel to the axis of rotation, but are set at an angle, such that the tooth shape is a segment of a helix. The angled teeth engage more gradually than spur gear teeth do. This causes helical gears to run more smoothly and quietly than spur gears. Furthermore, helical gears have higher capacity than spur gears since the tooth loads are distributed more evenly amongst several teeth in the mesh simultaneously whereas in a spur gear a single tooth carries majority of the load at any given time. Using helical gears for the planet gears provides higher power density and smoother operation, but they generate an overturning moment in a plane 90° to the tangential loads. The flex-pin described above can also be used to accommodate this overturning moment.

A typical planetary gear set uses several solid rigid shafts about which the planet gears rotate, mounted in a carrier. A planetary gear set can use flex-pins (in particular, flex-pins for helical gears) instead of the solid rigid shafts as a means to provide a controlled amount of flexibility in the system. This is desirable to keep the planet gear teeth aligned as well as to distribute the load evenly among the plurality of planet gears. However, introducing flexibility into the system lowers its natural frequency, which tends to exacerbate the potential for dynamic excitation and resonance and this in turn increases loads.

To address dynamics in prior systems, stiffness of the flex-pin is increased to drive the natural frequencies up and out of the operating range or a control system is used to avoid prolonged operation near a potential resonance condition. In a complex wind turbine gearbox with numerous natural frequencies these prior options become less practical, especially if many of the frequencies are lower due to flexibility introduced into the system (in particular, from a flex-pin).

Therefore, it is an object of the present invention to provide a solution to the dynamics issue by adding a high degree of damping into the system.

### SUMMARY OF THE INVENTION

This problem is solved by a gear assembly including a flexible pin mounted to and supported by a planet carrier at one end, wherein a′tubular sleeve extends coaxially about the flexible pin and provides a deflection space between said tubular sleeve and said flexible pin. Said flexible pin moves, flexes or deflects under operational loads. A damping element is contained at least partially within said deflection space and surrounds at least partially said flexible pin.

The invention provides a significant amount of damping in a gearbox that uses planetary gears with flex-pins (flexible pins). The invention entails integration of a damping element in the space between the flex-pin and the sleeve, which surrounds the flex-pin. This invention has several embodiments:
1) a viscous fluid such as oil is contained in a ring or space between the flex-pin and sleeve such that when the flex-pin moves the viscous fluid is forced to move around the flex-pin either with or without an orifice to meter flow or to dispense or transfer at least a part of the viscous fluid from one reservoir to another similar reservoir or to a dashpot, or
2) an elastomer ring is fitted on the flex-pin and in contact with the sleeve such that when the flex-pin moves the elastomer ring compresses and provides damping and increased stiffness, or
3) a viscous fluid such as oil is contained entirely in the volume or a shell-type compartment between the pin and sleeve such that when the pin moves the fluid is forced through a controlled orifice or seal. This is the preferred embodiment of the invention.

In this regard, according to an embodiment of the present invention, the damping element is an elastomer or friction spring arranged between said flex-pin and said tubular sleeve within said deflection space, wherein the said elastomer or friction spring compresses and provides damping as well as increased stiffness as the flexible pin deflects.

According to an alternative embodiment, the damping element is a viscous fluid contained within at least one volume arranged between said flexible pin and said tubular sleeve within said deflection space, wherein the viscous fluid is forced to move around the flexible pin (or between two volumes) as the flexible pin moves, flexes or deflects.

The invention has the advantage that by increasing damping, any potential excitation energy introduced into the system is quickly absorbed thereby reducing dynamic loads and also preventing the system from entering a resonant condition.

The invention has the advantage that it assists in the prevention of premature failure of the gearbox and tends to reduce dynamic drive train blade loading.

The invention has the advantage that it assists in the reduction of gearbox noise.

The invention also has the advantage that it reduces dynamic loading in the drive train up front to allow the machine to be designed more efficiently and requires less material to accommodate the loads, which results in lower mass and therefore lower cost.

The invention also has the advantage that it minimizes the potential for premature failure and reduced machine reliability, which are very costly.

The invention has the further advantage that it can be applied to heavy-duty transmissions where flexible pins reduce weight and cost plus the invention can be used in helical gears to achieve quiet running and further weight and size reduction.

According to an embodiment of the invention, the viscous fluid is trapped entirely with the volume between the pin and sleeve. Damping is achieved by movement of the pin within the viscous fluid.

Alternatively, a divider is provided between said flex-pin and said sleeve and divides said deflection space in said two volumes, wherein said divider between said two volumes provides an orifice or gap at said flex-pin configured to meter the flow or transfer at least a part of the viscous fluid from one volume to the other. The divider divides the deflection space in the axial length of the sleeve into two approximately semi-circular spaces or volumes. Between these two volumes the viscous fluid is transferred in case that the flex-pin moves, flexes or deflects under operational loads.

Alternatively, the two volumes are shell-type compartments defined by an inner wall, an outer wall and a separating wall between the flex-pin and the sleeve within the deflection space, wherein said separating wall comprises an orifice such that as the flex-pin moves the viscous fluid is forced through said orifice from one volume to the other volume.

According to another embodiment, the flexible pin comprises a channel to supply the at least one volume with viscous fluid.

According to a further embodiment, a bearing assembly is pressed into the planet gear. The bearing assembly can be a rolling element bearing or a fluid film bearing or can comprise tapered roller bearings.

### BRIEF DESCRIPTION OF THE DRAWINGS

The invention will be described in detail with reference to the drawings in which:

FIG. 1 is a sectional view of part of a gear transmission of a wind turbine in which the present invention is exemplarily embodied;

FIGS. 2A and 2B are diagrams showing schematically a gear assembly according to a first embodiment of the invention, in which an viscous fluid such as oil is contained in a ring or space between a flex-pin and sleeve which may include a gap or orifice to provide damping in the gear assembly of the gear transmission shown in FIG. 1, being of the type of a planetary system, wherein the flex-pin is undeflected;

FIGS. 3A and 3B are diagrams showing schematically the gear assembly according to the first embodiment of the invention, in which the viscous fluid such as oil is contained in the ring or space between the flex-pin and sleeve which may include a gap or orifice to provide damping in the gear transmission shown in FIG. 1, wherein the flex-pin is deflected;

FIG. 4 is a detailed illustration of a gap size controlled to meter flow or transfer at least a part of the viscous fluid between two volumes;

FIGS. 5A and 5B are diagrams of a gear assembly comprising an elastomer ring or friction spring to provide damping in the gear transmission of FIG. 1, wherein the flex-pin is un-deflected (FIG. 5A) and deflected (FIG. 5B);

FIGS. 6A and 6B are diagrams of a gear assembly according to a further embodiment of the invention, comprising a viscous fluid reservoir to provide damping in the gear transmission of FIG. 1, wherein the flex-pin is undeflected;

FIGS. 7A and 7B are diagrams of a gear assembly according to a further embodiment of the invention, comprising a viscous fluid reservoir to provide damping in the gear transmission of FIG. 1, wherein the flex-pin is deflected; and

FIG. 8 is a detailed illustration of an orifice to allow fluid flow between two volumes or shell-type compartments.

### DESCRIPTION

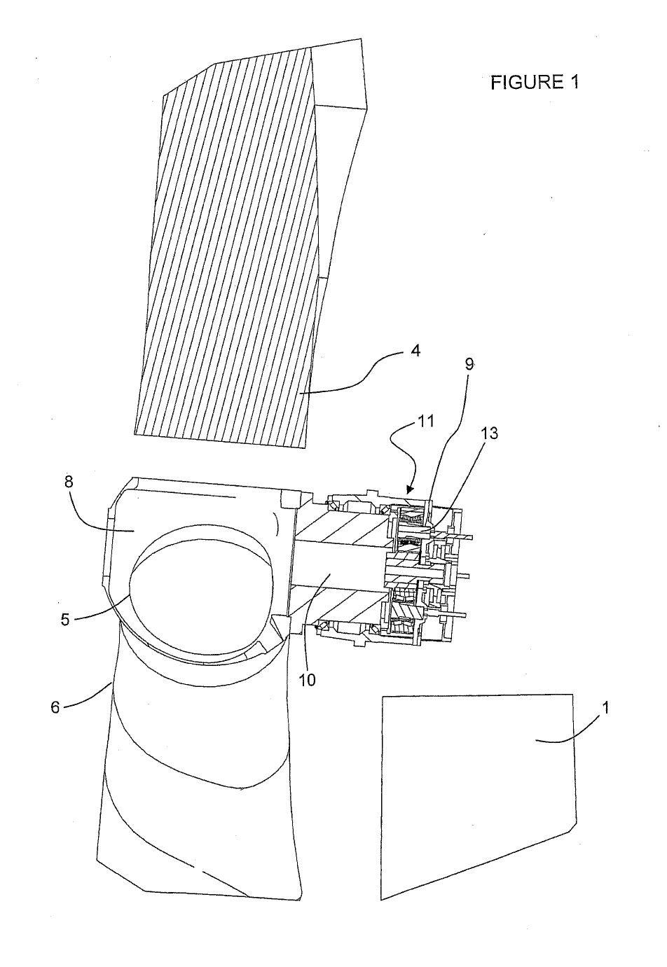

A wind turbine is a rotating machine, which converts wind energy into electrical energy. Rotor blades are connected to a gear transmission or gearbox, which turns the slow rotation of the blades into a faster rotation that is more suitable for driving electrical generators. The gearbox uses epicyclic gearing (planetary gearing) to step up the rotation of the rotor blades to drive a number of generators. The basic components of the system are shown in FIG. 1.

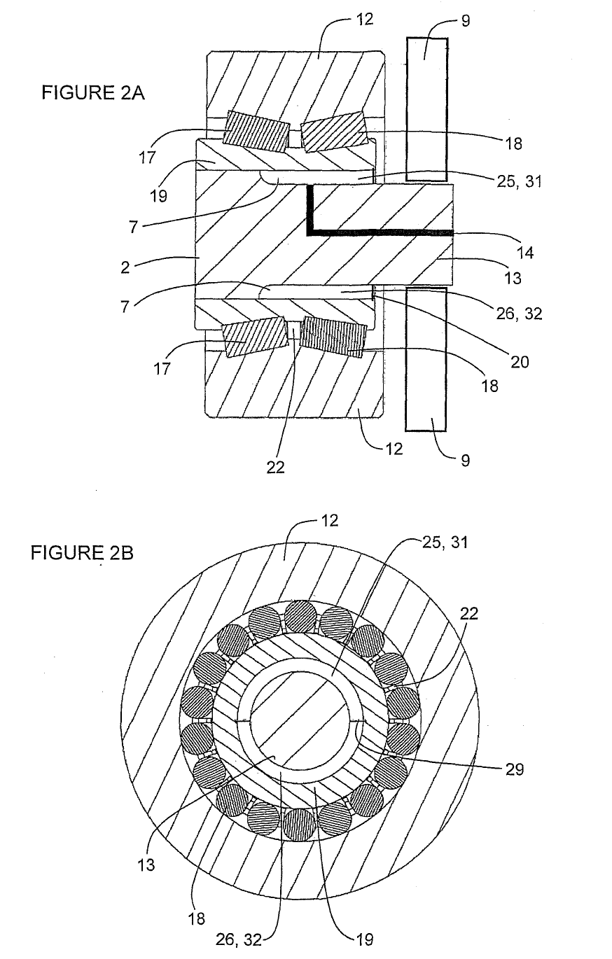

With respect to FIG. 1 and FIGS. 2A and 2B, the wind turbine sits atop a tower 1. Wind-driven rotor blades 4, 5, 6 turn a rotor hub 8, which turns a main shaft 10. The main shaft 10 drives a gear transmission drive train 11 comprising an epicyclic gear unit. The epicyclic gear unit includes a planet carrier 9 provided with a plurality of resilient or flexible pins 13, which are mounted to and supported by the planet carrier 9 at one end. A tubular sleeve 19 is mounted on the free end 2 of the flexible pin 13 and a damping element is contained between the flexible pin 13 and the tubular sleeve 19. The tubular sleeve 19 extends coaxially about the flexible pin 13 with a space 7 between the flexible pin 13 and the tubular sleeve 19, wherein the space 7 can be an annular space 7. Movement of the flexible pin 13 can take place within the annular space 7 without the flexible pin 13 making contact with the (inner) surface of the sleeve 13. The space 7 represents a deflection space 7 allowing the flexible pin (flex-pin) 13 to move and flex under operational loads. The sleeve 19 may carry a bearing and planet pinion or gear 12, which engages with an annulus gear and a sun pinion.

The gears of the epicyclic gear unit drive electrical generators. The epicyclic gear unit or system comprises three or more circumferentially spaced planet gear shafts. The epicyclic gear system further includes a ring gear, a plurality of planet gears, which are mounted on the planet gear shafts, a sun gear, and a planet carrier 9. The planet carrier 9 holds three or more peripheral planet gears, not shown in the drawings. The gears of the epicyclic gear unit provide outputs connected to generators, powered by the rotation of the rotor shaft 10.

A bearing assembly is pressed into the planet gear 12. The bearing assembly can comprise a rolling element bearing or a fluid film bearing. In this specific embodiment, tapered roller bearings 17, 18 are used as illustrated in the FIGURES.

At the free end 2 of the flexible pin 13, the tubular sleeve 19 and the bearing assembly 17, 18 support a gear on each gear shaft, shown in FIG. 1. Under load, opposing bending forces in the sleeve 19 and flexible pin 13 offset one another, resulting in zero misalignment across a broad range of torque. This enables much simpler gear design and increased torque capacity.

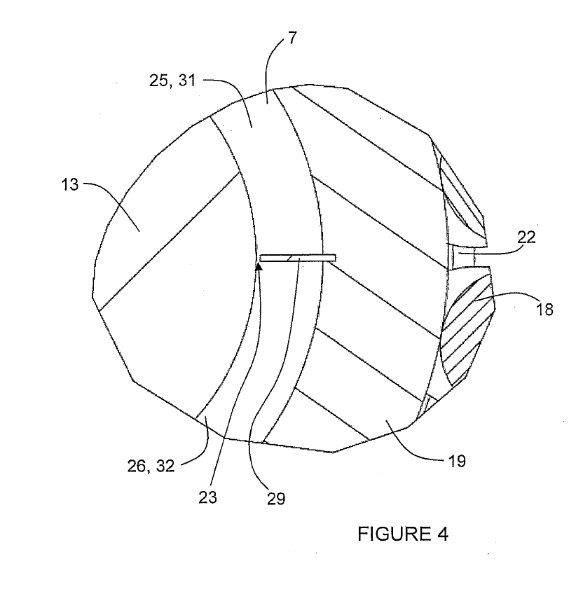

In the first embodiment, shown in FIGS. 2-4, a viscous fluid such as oil is contained in the deflection space 7 by a ring 25, 26 between the flexible pin or flex-pin 13 and the sleeve 19 such that when the flex-pin 13 moves the viscous fluid is forced to move around the flex-pin 13 either with or without a divider to create an orifice or gap 23 (FIG. 4) to meter flow or transfer at least a part of the viscous fluid from a first reservoir 31 to a second reservoir 32 or to a dashpot. FIG. 2A and FIG. 2B are diagrams wherein the flex-pin is un-deflected. The viscous fluid is in a volume 25 of the first reservoir 31 and volume 26 of the second reservoir 32.

Refer to FIG. 4, which is a detailed illustration of a gap size controlled to meter flow or transfer at least a part of the viscous fluid between the two volumes 25, 26 (first and second reservoirs 31, 32). A divider 29 between the two volumes 25, 26 provides an orifice or a gap 23 at the flex-pin sized to meter the flow or transfer at least a part of the viscous fluid from one volume to the other. The divider 29 can be a separate piece or an integral part of the tubular sleeve 19 to provide the gap 23 at the flex-pin 13 (as shown in FIG. 4) or alternatively, the divider 29 can be an integral part of the flex-pin 13 to provide the gap 23 at the tubular sleeve 19.

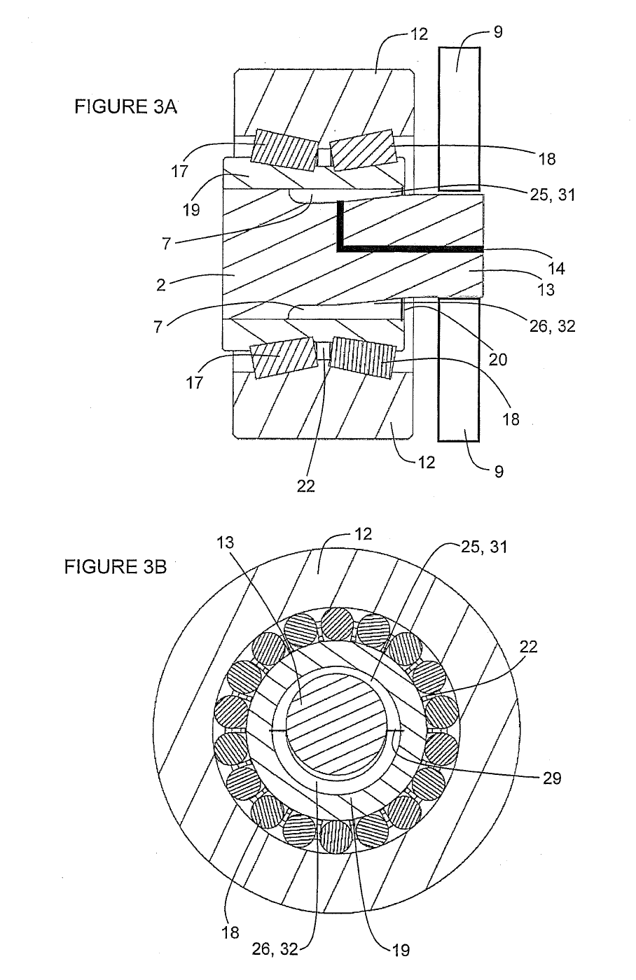

Refer to FIGS. 3A and 3B, which are diagrams wherein the flex-pin 13 shown in FIG. 2A and B is deflected. When the flex-pin 13 moves, the viscous fluid acts as a damper, which resists motion via viscous friction. The resulting force acts in the opposite direction to the motion of the flex-pin 13, slowing the motion and absorbing energy. The divider 29 which may be present between the two volumes 25, 26 forms the gap 23, the size of which may be controlled to meter the flow between the two volumes 25, 26.

With respect to FIGS. 2A and 3A, the flexible pin 13 comprises a channel 14 to supply the deflection space 7 with the viscous fluid. The channel 14 comprises two sections, wherein the first section is arranged in part approximately in the centre of the flexible pin 13 and the second section extends radially in the direction of the deflection space 7 in order to supply at least one of the volumes 25, 26 with the viscous fluid.

Gearbox oil, which is a synthetic VG 320, is used although it could be any oil or viscous fluid. It could be of any viscosity grade or additive package or a mineral oil, they would all work the same way.

The fluid may be held within a sealed volume, or if it is a leaky volume the oil may need to be replenished and constantly pumped into the volume to maintain a pressure and make up for the leakage. The oil would easily flow out the large open end of the tubular sleeve 19, so a seal 20 is required. A piston ring or labyrinth type seal or elastomer seal such as an O-ring allows movement of the flex-pin 13 and sleeve 19, which is required for the flex-pin 13 to work, yet maintain some degree of sealing to allow the viscous fluid or oil to fill the volumes 25, 26. It can leak around that piston seal a controlled amount, which is permissible. The oil also will leak out through small holes in the sleeve 19 to squirt oil on the bearing rollers 18 on the outside of the sleeve. A piston ring type seal is a steel ring that fits closely (but allows movement) in a groove on both the flex-pin 13 and sleeve 19. It is built into either the sleeve 19 or flex-pin 13, i.e. integrated to the part by simply machining it in on one side with a mating groove on the other.

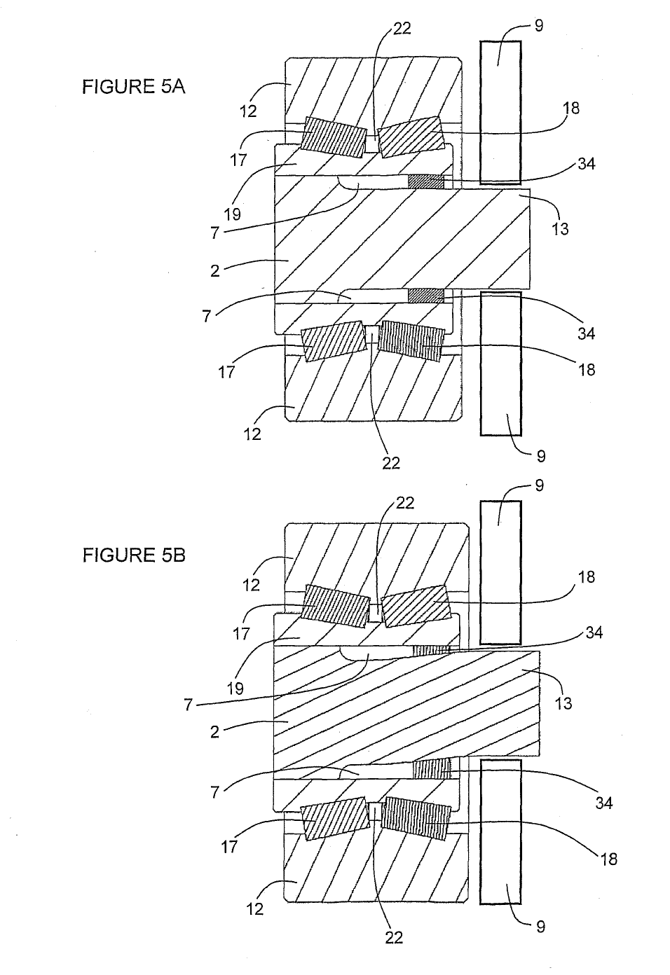

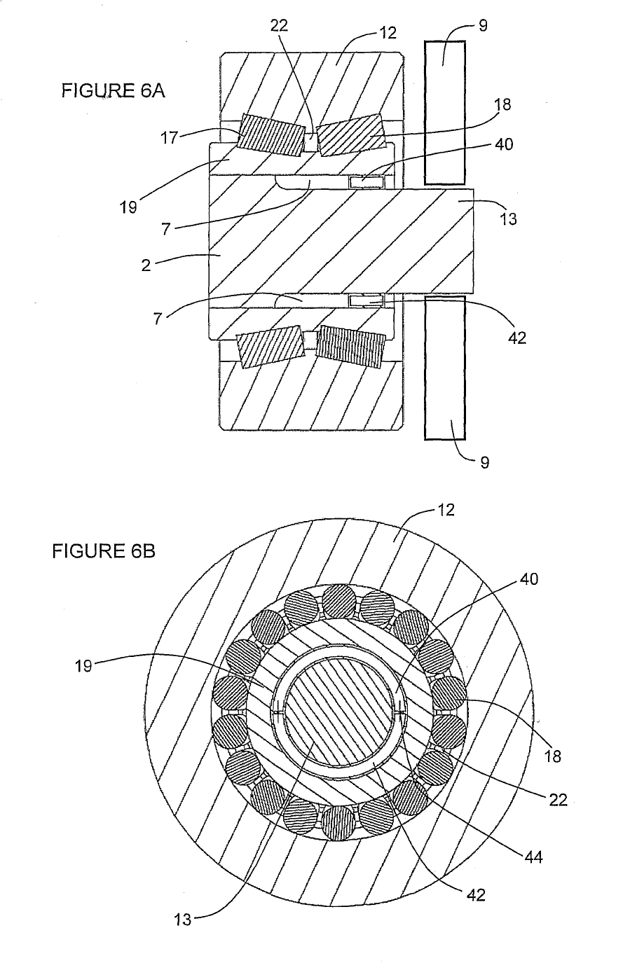

According to another embodiment shown in FIGS. 5-6, an elastomer ring 34 is fitted on the flex-pin 13 and in contact with the sleeve 19 such that when the flex-pin moves (as designed) the elastomer ring 34 compresses and provides damping as well as increased stiffness. Alternatively, a friction spring can be used and fitted on the flex-pin 13. The flex-pin is shown un-deflected (FIG. 5A) and deflected (FIG. 5B).

According to a further embodiment shown in FIGS. 6-8, a viscous fluid such as oil is contained by an inner wall 46 and a outer wall 48 entirely in the volume 40, 42 between the flex-pin 13 and sleeve 19 such that when the flex-pin 13 moves the viscous fluid is forced through a controlled orifice or seal 44 in the wall of the containment. This is the preferred embodiment of the invention.

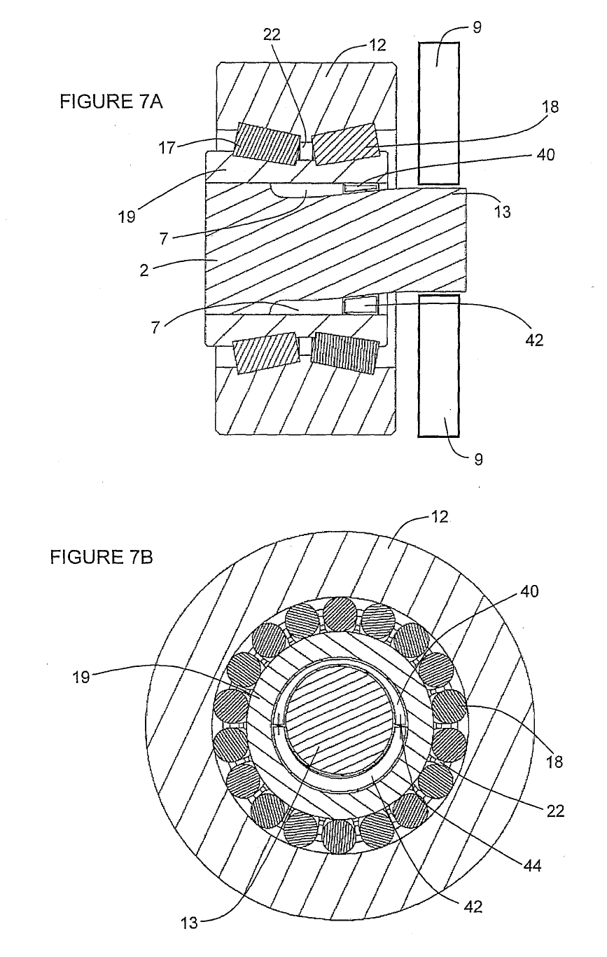

Refer to FIGS. 6A and 6B, which are diagrams of a flex-pin 13 with a viscous fluid reservoir to provide damping in the planetary system of FIG. 1, wherein the flex-pin 13 is un-deflected. FIGS. 7A and 7B show the flex-pin 13 deflected upwards and the volume 40 compressed.

In this embodiment, the reservoir is essentially the control volume 40 on one side of the flex-pin 13 vs. the other volume 42. However, it can be a completely separate reservoir, but that just adds complexity and cost. It can simply be the flex-pin 13 moving around in the viscous fluid or it can have features on either the flex-pin 13 or sleeve 19 or a separate divider to better isolate the volumes (i.e. control the orifice/flow resistance and damping from one volume to the other volume). A piston ring type seal to control or limit the leakage axially is required. Its purpose is to keep the volume full of viscous fluid so it can leak, but the more it leaks the more fluid has to be pumped in.

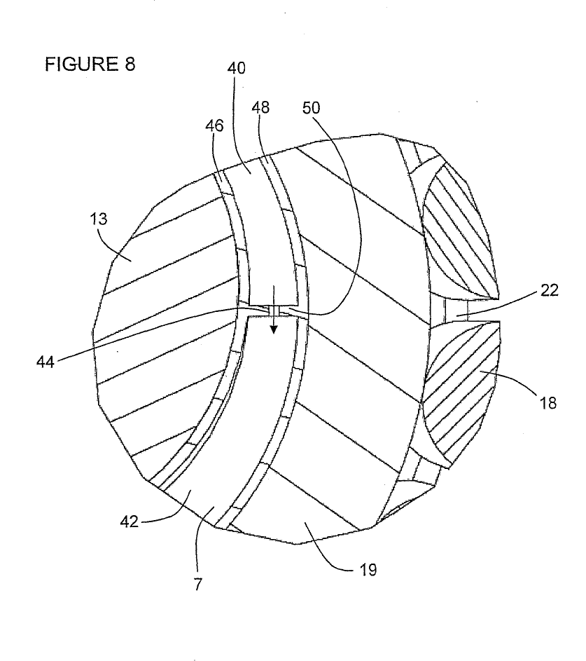

Refer to FIG. 8, which is a detailed illustration of the orifice 44, which allows fluid flow between the two volumes 40 and 42. As the flex-pin 13 deflects upwards, the viscous fluid in volume 40 is compressed and forced to flow in the direction of the arrow into volume 42.

With respect to the embodiments shown in FIGS. 5A, 5B, 6A, 6B and 7A, the flexible pin 13 also may comprise a channel to supply the deflection space 7 and/or at least one of the volumes 40, 42 with viscous fluid. The shape of that channel may be similar to the shape of the embodiment shown in FIGURES. 2A, 2B.

Those skilled in the art will understand that whereas the invention is described with reference to wind or water current sources of power driving to generators to generate electricity, other sources of power may be utilized to impart torque to the main shaft. Also the invention has been described with reference to electric generations being driven by the multi-stage gearing disclosed. Those skilled in the art will understand that any rotational device or devices may be driven by the gearing. The sources of power and respective appropriate rotational devices driven by the gearing include, but are not limited to (1) fossil fuels, such as diesel motor-generator sets and gas turbines; (2) nuclear fuels, such as steam turbines for nuclear power plants; (3) solar energy; (4) bio-energy technologies, such as making use of renewable plant material animal wastes and industrial waste; (5) thermal energy; (6) automotive energy, such as electric cars; (7) tunnel boring equipment; (8) mining equipment; (9) micro-turbines, such as those using natural gas, gas from landfills or digester gas; (10) marine drives; and (11) other heavy equipment with a low speed drive, such as rotating cement mixers and earth moving equipment. Likewise, the role of generators may be replaced by prime movers, such as motors, to create a reduction gearbox to drive machines requiring high torque and slow speeds.

While the invention has been particularly shown and described with reference to preferred embodiments thereof, those skilled in the art will understand that the foregoing and other changes in form and detail may be made therein without departing from the scope of the invention.

The present invention relates a gear assembly including a flexible pin 13 mounted at one end in a tubular sleeve 19, wherein the pin flexes under operational loads. A damping element is contained at least partially within a space between said sleeve 19 and said pin 13 and surrounds said pin.

According to one embodiment, the damping element is a viscous fluid contained between the pin and sleeve such that as the pin deflects the fluid is forced to move around the pin either with or without an orifice to meter flow from one reservoir 25 to another similar reservoir 26.

According to a further embodiment, the damping element is an elastomer ring 34 fitted on the flex-pin 13 and in contact with the sleeve 19 such that as the flex-pin deflects the elastomer ring compresses and provides damping as well as increased stiffness.

According to another embodiment, the damping element is a viscous fluid contained in volumes 40, 42 between the pin 13 and sleeve 19 such that as the pin moves the fluid is forced through an orifice 44 from one volume 40 to the other volume 42.

1. A gear assembly including a flexible pin (13) mounted to and supported by a planet carrier at one end, wherein
a tubular sleeve extends coaxially about the flexible pin (13) and provides a deflection space between said tubular sleeve and said flexible pin,
said flexible pin moves, flexes or deflects under operational loads, and
a damping element is contained at least partially within said deflection space and surrounds at least partially said flexible pin.

2. The gear assembly of claim 1, wherein said damping element is an elastomer or friction spring arranged between said flex-pin and said tubular sleeve within said deflection space, wherein the said elastomer or friction spring compresses and provides damping as well as increased stiffness as the flexible pin deflects.

3. The gear assembly of claim 1, wherein said damping element is a viscous fluid contained within at least one volume arranged between said flexible pin and said tubular sleeve within said deflection space, wherein the viscous fluid is forced to move around the flexible pin as the flexible pin moves, flexes or deflects.

4. The gear assembly of claim 3, wherein a divider is provided between said flex-pin and said sleeve and divides said deflection space in at least two volumes, wherein said divider between said two volumes provides an orifice or gap at said flex-pin configured to meter the flow or transfer at least a part of the viscous fluid from one volume to the other.

5. The gear assembly of claim 4, wherein the two volumes are shell-type compartments defined by an inner wall, an outer wall and a separating wall between the flexible pin and the sleeve within the deflection space, wherein said separating wall comprises an orifice such that as the flex-pin moves the viscous fluid is forced through said orifice from one volume to the other volume.

6. The gear assembly according to claim 1, wherein the flexible pin comprises a channel to supply the at least one volume with viscous fluid.

7. The gear assembly according to claim 1, wherein a bearing assembly is pressed into the planet gear.

8. The gear assembly according to claim 7, wherein the bearing assembly is a rolling element bearing or a fluid film bearing or comprises tapered roller bearings.
